(19) United States
(12) Patent Application Publication
(10) Pub. No.: US 2016/0196239 A1
(43) Pub. Date: Jul. 7, 2016

(54) METHOD, TERMINAL DEVICE AND SYSTEM FOR DISPLAYING CONTENT OF SHORT MESSAGE

(71) Applicant: Xiaomi Inc., Beijing (CN)

(72) Inventors: Yuxiang Liu, Beijing (CN); Zhenhai Zhao, Beijing (CN); Pingze Wang, Beijing (CN); Anting Zhao, Beijing (CN); Bin Wang, Beijing (CN); Bo Zhang, Beijing (CN); Mingze Sun, Beijing (CN)

(21) Appl. No.: 14/977,609

(22) Filed: Dec. 21, 2015

(30) Foreign Application Priority Data
Jan. 5, 2015 (CN) 201510004913.5

(51) Int. Cl. G06F 17/21; H04L 12/58; G06F 3/0484

(52) U.S. Cl. CPC G06F 17/212; G06F 3/04842; H04L 51/043; H04L 51/26

(57) ABSTRACT

A method, a terminal device and a system for displaying content of a short message are provided, so as to improve the diversification of displaying the short message. The method for displaying content of a short message includes: receiving the content of the short message from a short message transmitting terminal and determining a telephone number corresponding to the short message transmitting terminal; determining a displaying style of the content of the short message from a short message displaying rule database according to the telephone number and the content of the short message; and displaying the content of the short message in a short message application of the terminal device according to the displaying style.

### CROSS-REFERENCE TO RELATED APPLICATIONS

This application is based upon and claims priority to Chinese Patent Application No. 201510004913.5, filed with the State Intellectual Property Office of P. R. China on Jan. 5, 2015, the entire contents of which are incorporated herein by reference.

### TECHNICAL FIELD

The present disclosure relates to the field of communication technologies, and more particularly, to a method, a terminal device and a system for displaying content of a short message. Moreover, the present disclosure also relates to a method and a server for determining a display of the short message.

### BACKGROUND

The short message, as a carrier for information transmission, realizes a peer to peer (P2P) communication function and a business to customer (B2C) notification function. In the related art, the short message, as a medium of transferring a text or a photograph, transfers attached information or instructions to a user via the content of the short message. For example, an operator may send a short message indicating that “the balance of the mobile is insufficient, please refill the mobile” to the user. After the user receives the short message, he/she needs to exit the short message application, and further performs a corresponding refill operation to refill the mobile. The single displaying style of the short message in the related art results in a reduced user experience of using the short message.

### SUMMARY

According to a first aspect of embodiments of the present disclosure, there is provided a method for displaying content of a short message in a terminal device, including: receiving the content of the short message from a short message transmitting terminal and determining a telephone number corresponding to the short message transmitting terminal; determining a displaying style of the content of the short message from a short message displaying rule database according to the telephone number and the content of the short message; and displaying the content of the short message in a short message application of the terminal device according to the displaying style.

According to a second aspect of embodiments of the present disclosure, there is provided a terminal device for displaying content of a short message, including: a processor; and a memory for storing instructions executable by the processor, wherein the processor is configured to: receive the content of the short message from a short message transmitting terminal and determine a telephone number corresponding to the short message transmitting terminal; determine a displaying style of the content of the short message from a short message displaying rule database according to the telephone number and the content of the short message; and display the content of the short message in a short message application of the terminal device according to the displaying style.

According to a third aspect of embodiments of the present disclosure, there is provided a server for determining a display of a short message, including: a processor; and a memory for storing instructions executable by the processor, wherein the processor is configured to: receive a custom displaying style about content of the short message sent to a terminal device from a short message transmitting terminal; store the custom displaying style in a short message displaying rule database; and send the short message displaying rule database to the terminal device.

According to a fourth aspect of embodiments of the present disclosure, there is provided a system for displaying content of a short message, including a server and a terminal device; wherein the server is configured to receive a custom displaying style about the content of the short message sent to the terminal device from a short message transmitting terminal; store the custom displaying style in a short message displaying rule database; and send the short message displaying rule database to the terminal device; the terminal device is configured to receive the content of the short message from the short message transmitting terminal and determine a telephone number corresponding to the short message transmitting terminal; determine a displaying style of the content of the short from the short message displaying rule database according to the telephone number and the content of the short message; and display the content of the short message in a short message application of the terminal device according to the displaying style.

The embodiments of the present disclosure may have advantageous effects as follow. The displaying style of the content of the short message in the short message application of the terminal device is determined from the short message displaying rule database according to the telephone number and the content of the short message, and the content of the short message is displayed by the short message application according to the displaying style, so that the content of the short message may be displayed in diverse ways in the terminal device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart showing a method for displaying content of a short message according to an exemplary embodiment.

FIG. 1B is a schematic diagram illustrating a short message displayed in a short message application according to an exemplary embodiment.

FIG. 1C is another schematic diagram illustrating a short message displayed in a short message application according to an exemplary embodiment.

FIG. 2A is a flow chart showing a method for displaying content of a short message according to a first exemplary embodiment.

FIG. 2B is a schematic diagram illustrating a short message displayed in a short message application according to a first exemplary embodiment.

FIG. 2C is another schematic diagram illustrating a short message displayed in a short message application according to a first exemplary embodiment.

FIG. 3A is a flow chart showing a method for displaying content of a short message according to a second exemplary embodiment.

FIG. 3B is a schematic diagram illustrating a short message displayed in a short message application according to a second exemplary embodiment.

FIG. 3C is another schematic diagram illustrating a short message displayed in a short message application according to a second exemplary embodiment.

FIG. 4 is a flow chart showing a method for determining a display of a short message according to an exemplary embodiment.

FIG. 5A is a schematic diagram illustrating how to configure a short message displaying rule database according to an exemplary embodiment.

FIG. 5B is a schematic diagram illustrating a custom displaying style of content of a short message according to an exemplary embodiment.

FIG. 6 is a block diagram showing a device for displaying content of a short message according to an exemplary embodiment.

FIG. 7 is a block diagram showing another device for displaying content of a short message according to an exemplary embodiment.

FIG. 8 is a block diagram showing a device for determining a display of a short message according to an exemplary embodiment.

FIG. 9 is a block diagram showing another device for determining a display of a short message according to an exemplary embodiment.

FIG. 10 is a block diagram suitable for a terminal device for displaying content of a short message according to an exemplary embodiment.

FIG. 11 is a block diagram suitable for a server for determining a display of a short message according to an exemplary embodiment.

FIG. 12 is a block diagram showing a system for displaying content of a short message according to an exemplary embodiment.

### DETAILED DESCRIPTION

Reference will now be made in detail to exemplary embodiments, and examples are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

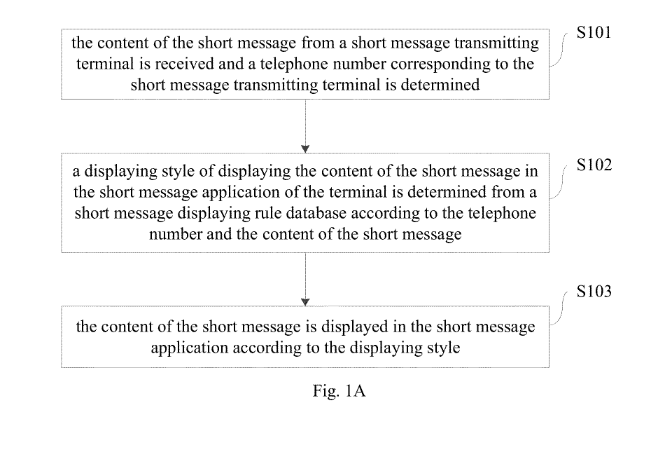

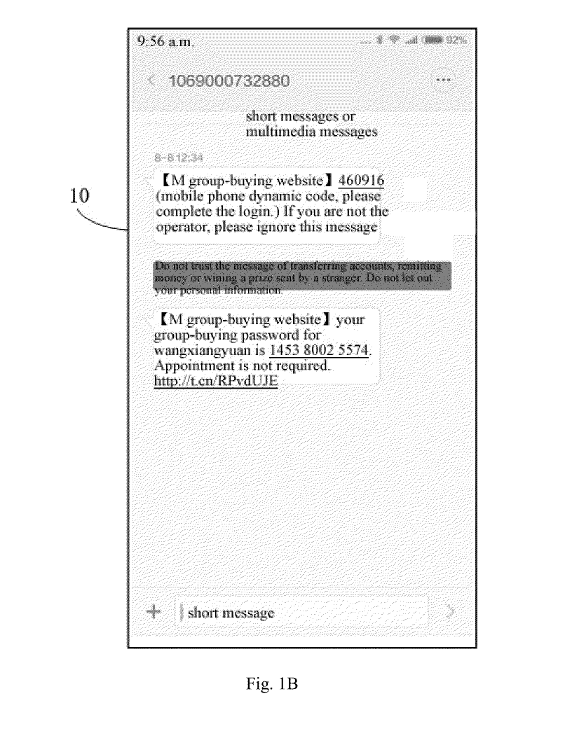

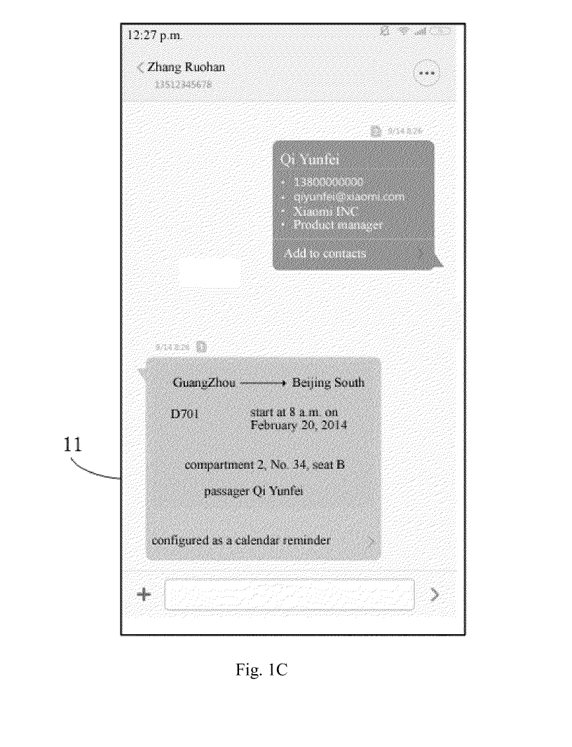

FIG. 1A is a flow chart showing a method for displaying content of a short message according to an exemplary embodiment, FIG. 1B is a schematic diagram illustrating a short message displayed in a short message application according to an exemplary embodiment, and FIG. 1C is another schematic diagram illustrating a short message displayed in a short message application according to an exemplary embodiment. The method for displaying content of a short message may be applied to a terminal device (for example: a smart phone, a tablet) and may display the content of the short message by installing a short message application in a terminal device. As shown in FIG. 1A, the method for displaying content of a short message includes following steps S101-S103.

In step S101, the content of the short message from a short message transmitting terminal is received and a telephone number corresponding to the short message transmitting terminal is determined.

In an embodiment of the present disclosure, the short message transmitting terminal may be a terminal device. In an embodiment of the present disclosure, the content of the short message may be the content of the short message sent by an ordinary user via the terminal device to another terminal device, a notification message sent by a merchant via the electronic business platform to the terminal device, or a reminder message sent by a telecom operator via its telecom operating server to the terminal device. In an embodiment of the present disclosure, the telephone number of the short message transmitting terminal may be a customer service telephone number provided by the merchant, a customer service telephone number provided by the telecom operator, or a telephone number of the ordinary user.

In step S102, a displaying style of the content of the short message in the short message application of the terminal device is determined from a short message displaying rule database according to the telephone number and the content of the short message.

In an embodiment of the present disclosure, each displaying rule in the short message displaying rule database may include: the telephone number or a segment of the telephone number, characteristics of the content of the short message, the displaying styles corresponding to different content of the short message and/or telephone numbers and operations needed to be provided in the user interface of the short message application (for example, performing a jump according to an operation of clicking a button by the user, performing a jump according to a text link, etc.). For example, if the terminal device receives the reminder message sent from the customer service telephone number of the telecom operator, the corresponding displaying style in the short message displaying rule database may be determined according to the customer service telephone number of the telecom operator. Alternatively, if the terminal device receives the notification message sent from the merchant via the electronic business platform, the corresponding displaying style in the short message displaying rule database may be determined according to the customer service telephone number corresponding to the electronic business platform. Further, if the terminal device receives the ordinary short message from the short message transmitting terminal, the corresponding displaying style in the short message displaying rule database may be determined according to the content of the short message.

In step S103, the content of the short message is displayed in the short message application according to the displaying style.

In an embodiment of the present disclosure, as shown in FIG. 1B, the content of the short message sent by the merchant of the M group-buying website via the customer service telephone number 1069000732880 to the short message application 10 of the terminal device is displayed. In the displayed content of the short message, “http://t.cn/RPvdUJE” is displayed in a form of link in the interface of the short message application, while the dynamic code “460916” and the group-buying password “145380025574” are displayed in a form of consecutive characters. By this style of displaying the content of the short message, the user may directly obtain the key information in the content of the short message, for example, the dynamic code “460916” and the group-buying password “145380025574.” And since “http://t.cn/RPvdUJE” is displayed in a form of link, if the user clicks the link, the URL corresponding to the link may be shown directly, such that the user needs not manually input the link into the browser, thus greatly increasing the convenience of the user operation. In another embodiment of the present disclosure, as shown in FIG. 1C, if the ordinal user “Qi Yunfei” sends the short message about personal information of “Qi Yunfei” to “Zhang Ruohan,” the corresponding displaying style in the short message displaying rule database may be determined to be a business card style according to the content of the short message. If “Zhang Ruohan” sends the short message about train ticket information to “Qi Yunfei” and the terminal device of “Qi Yunfei” detects that the content of the short message is the train ticket information, then the terminal device searches for the displaying style corresponding to the train ticket in the short message displaying rule database, and then displays the content of the short message in a form of train ticket to “Qi Yunfei.” Therefore, there are a variety of displaying styles for displaying the content of the short message in the short message application of the terminal device held by “Qi Yunfei.”

In this embodiment of the present disclosure, the displaying style of the content of the short message in the short message application of the terminal device is determined from the short message displaying rule database according to the telephone number and the content of the short message, and the content of the short message is displayed in the short message application according to the displaying style, so that the content of the short message may be displayed in diverse ways in the terminal device.

In an embodiment of the present disclosure, step S102 includes following steps of: determining priorities of the telephone number and the content of the short message for the displaying style of the content of the short message according to a first displaying rule in the short message displaying rule database; determining the displaying style of the content of the short message in the short message application of the terminal device according to the priorities.

If the priority of the content of the short message is higher than that of the telephone number, determining the displaying style of the content of the short message in the short message application of the terminal device according to the priorities includes following steps of: identifying consecutive characters in the content of the short message according to a second displaying rule in the short message displaying rule database; determining a displaying style of the consecutive characters as a text link in the short message application of the terminal device.

In an embodiment of the present disclosure, the method for displaying content of a short message further includes following steps of: monitoring whether the text link is clicked by a user; and determining to jump from a user interface of the short message application to a first user interface corresponding to the text link if it is monitored that the text link is clicked by the user.

In an embodiment of the present disclosure, if the priority of the telephone number is higher than that of the content of the short message, determining the displaying style of the content of the short message in the short message application of the terminal device according to the priorities includes following steps of: identifying a third displaying rule determined by the short message transmitting terminal corresponding to the telephone number in the short message displaying rule database; determining a button associated with the content of the short message according to the third displaying rule.

In an embodiment of the present disclosure, the method for displaying content of a short message further includes following steps of: monitoring whether the button is clicked by a user; and determining to jump from a user interface of the short message application to a second user interface corresponding to the button if it is monitored that the button is clicked by the user.

In an embodiment of the present disclosure, the short message displaying rule database is updated if it is determined that displaying styles in the short message displaying rule database are updated.

Concerning details about how to display the content of the short message in the terminal device, reference is made to the following embodiments.

Thus, with the above described methods provided by embodiments of the present disclosure, the displaying style of the content of the short message in the short message application of the terminal device is determined from the short message displaying rule database according to the telephone number and the content of the short message, and the content of the short message is displayed in the short message application according to the displaying style, such that the content of the short message may be displayed in diverse ways in the terminal device. Further, an operation related to the content of the short message may be added by means of the short message displaying rule database, and if the user performs the operation related to the content of the short message, the corresponding redirection may occur on the interface of the content of the short message, thus avoiding the case that the user needs to perform the operation related to the content of the short message manually after closing the short message, and greatly increasing the convenience of performing the operation based on the content of the short message for the user.

The embodiments of the present disclosure may be illustrated with reference to specific embodiments as follows.

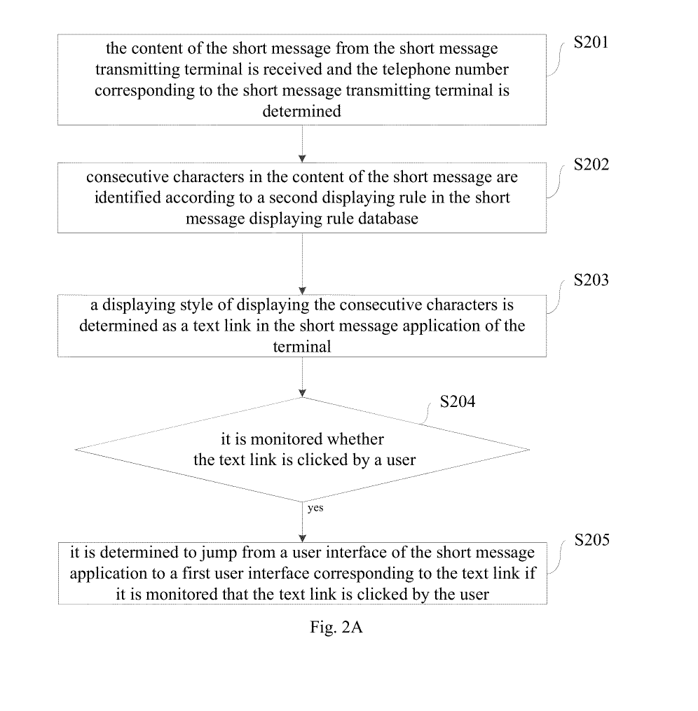

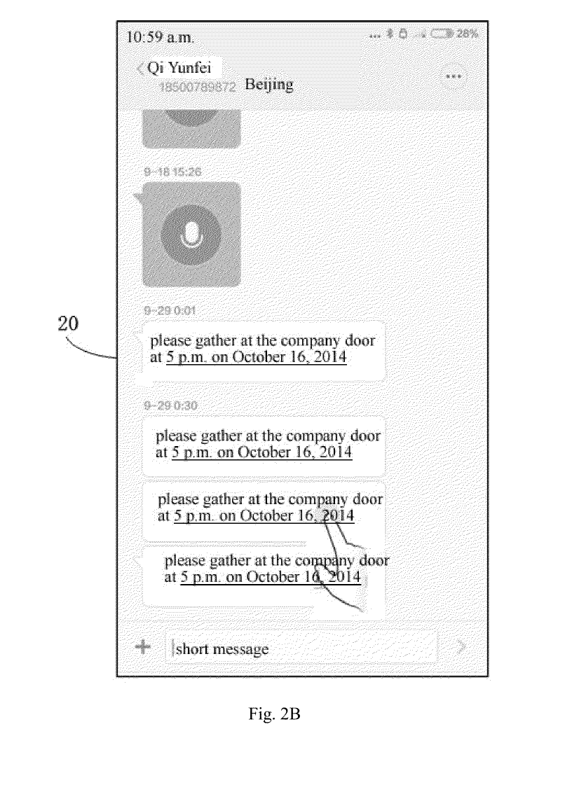

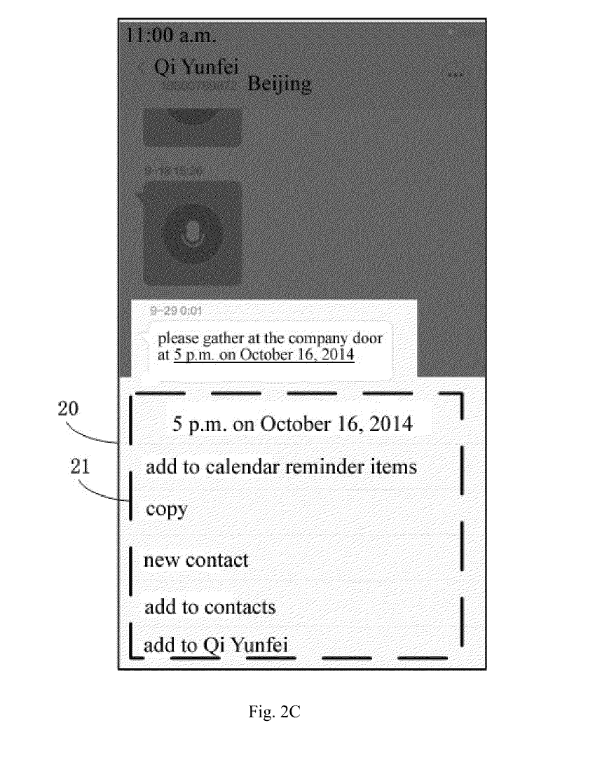

FIG. 2A is a flow chart showing a method for displaying content of a short message according to a first exemplary embodiment, FIG. 2B is a schematic diagram illustrating a short message displayed in a short message application according to a first exemplary embodiment, and FIG. 2C is another schematic diagram illustrating a short message displayed in a short message application according to a first exemplary embodiment. In this embodiment, with the above described methods provided by the embodiments of the present disclosure, take the priority of the content of the short message being higher than that of the telephone number as an exemplary illustration. The priorities of the telephone number and the content of the short message for the displaying style of the content of the short message may be determined according to the first displaying rule in the short message displaying rule database. The first displaying rule may be determined by the merchant or by the telecom operator. Assume that the first displaying rule may stipulate that the displaying style is determined according to the telephone number or according to the content of the short message. As shown in FIG. 2A, following steps are included.

In step S201, the content of the short message from the short message transmitting terminal is received and the telephone number corresponding to the short message transmitting terminal is determined.

Concerning the description of step S201, reference is made to the description of step S101, which will not be elaborated herein.

In step S202, consecutive characters in the content of the short message are identified according to a second displaying rule in the short message displaying rule database.

In an embodiment of the present disclosure, the consecutive characters may be a time and date, an expressage order number, a group-buying identification code, a number identification, a merchant name or a personal name identification, etc. As shown in FIG. 2B, the content of the short message “please gather at the company door at 5 p.m. on Oct. 16, 2014” is displayed in the short message application (app) 20, and the consecutive characters “5 p.m. on Oct. 16, 2014” may be identified according to the second displaying rule in the short message displaying rule database.

In step S203, a displaying style of the consecutive characters is determined as a text link in the short message application of the terminal device.

In an embodiment of the present disclosure, as shown in FIG. 2B, the consecutive characters “5 p.m. on Oct. 16, 2014” may be displayed in the style of the text link.

In step S204, it is monitored whether the text link is clicked by a user.

In step S205, it is determined to jump from a user interface of the short message application to a first user interface corresponding to the text link if it is monitored that the text link is clicked by the user.

In an embodiment of the present disclosure, as shown in FIG. 2C, if the user clicks the text link “5 p.m. on Oct. 16, 2014,” the first user interface 21 corresponding to the text link may be shown. The user may perform the reminder operation or other operations related to the content of the short message on the matters needed to be done on this day by an option “add to calendar reminder items” in the first user interface 21.

In this embodiment, the displaying style of the content of the short message in the short message application of the terminal device is determined from the short message displaying rule database according to the telephone number and the content of the short message, and the content of the short message is displayed in the short message application according to the displaying style, such that the displayed content of the short message may include the text link with which the user may perform the related operations, and a corresponding redirection may occur by means of the text link in the interface of the content of the short message, thus avoiding the case that the user needs to perform the operation related to the content of the short message manually after closing the short message, and greatly increasing the convenience of performing the operation based on the content of the short message for the user.

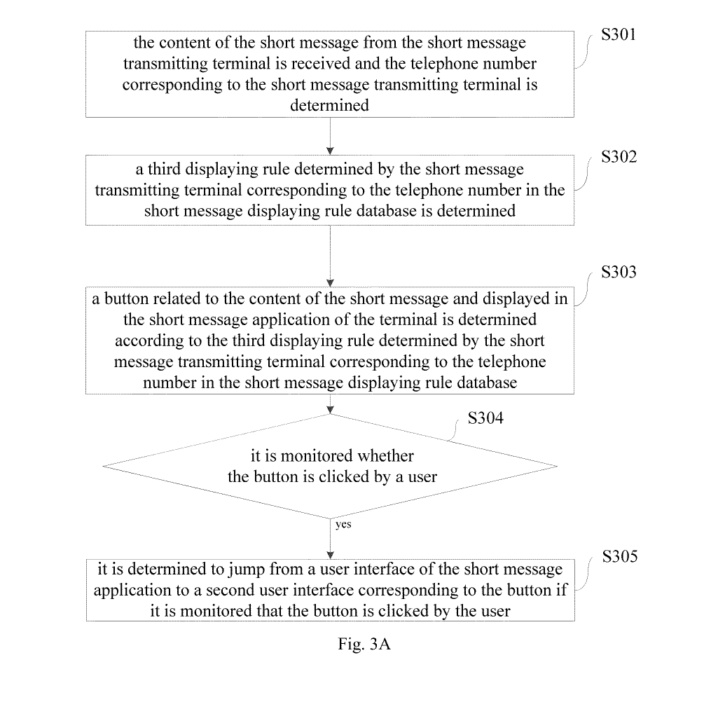

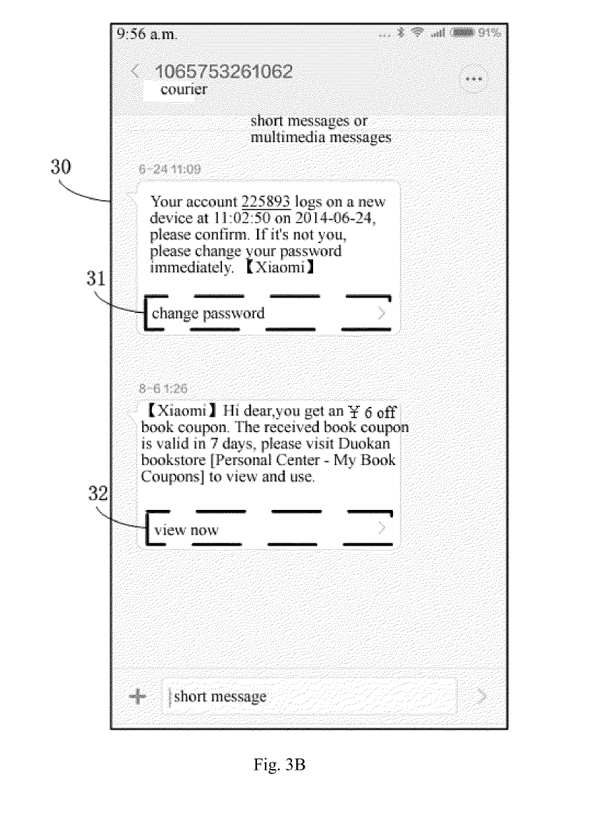

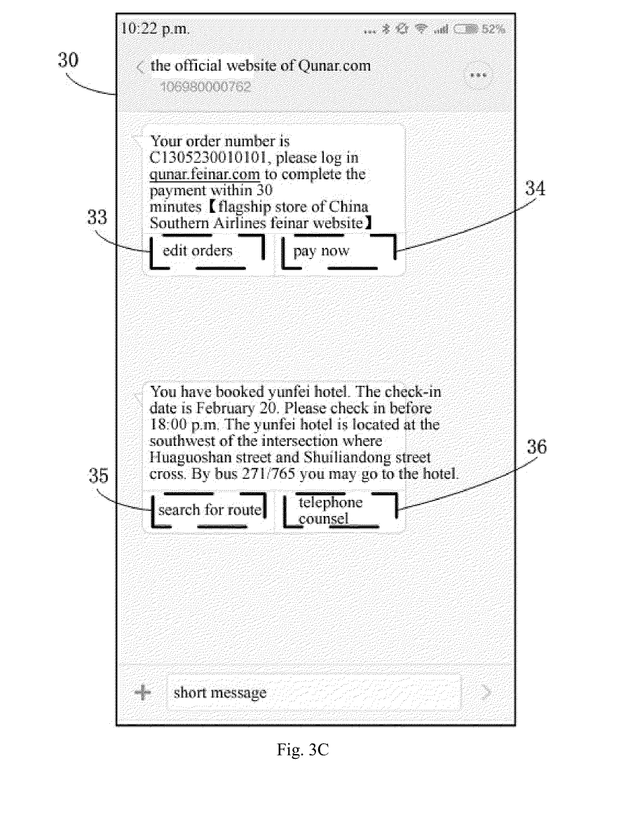

FIG. 3A is a flow chart showing a method for displaying content of a short message according to a second exemplary embodiment, FIG. 3B is a schematic diagram illustrating a short message displayed in a short message application according to a second exemplary embodiment, and FIG. 3C is another schematic diagram illustrating a short message displayed in a short message application according to a second exemplary embodiment. In this embodiment, with the above described methods provided by the embodiments of the present disclosure, take the priority of the telephone number being higher than that of the content of the short message as an exemplary illustration. The priorities of the telephone number and the content of the short message for the displaying style of the content of the short message may be determined according to the first displaying rule in the short message displaying rule database. The first displaying rule may be determined by the merchant or by the operator. Assume that the first displaying rule may stipulate that the displaying style is determined according to the telephone number or according to the content of the short message. As shown in FIG. 3A, following steps are included.

In step S301, the content of the short message from the short message transmitting terminal is received and the telephone number corresponding to the short message transmitting terminal is determined.

Concerning the description of step S301, reference is made to the description of step S101, which will not be elaborated herein.

In step S302, a third displaying rule determined by the short message transmitting terminal corresponding to the telephone number in the short message displaying rule database is identified.

In step S303, a button associated with the content of the short message is determined according to the third displaying rule. Moreover, the button will be displayed by the short message application of the terminal device.

In an embodiment of the present disclosure, if the customer service telephone number corresponding to the short message transmitting terminal is the service telephone number provided by the electronic business platform, the short message transmitting terminal may customize the displaying style of the content of the short message to be sent according to the service telephone number. As shown in FIG. 3B, there is the content of the short messages sent by the courier with the telephone number “1065753261062” to the terminal device. In the content of the first short message, since the content of the first short message refers to the password security, the button 31 “change password” is provided. In the content of the second short message, since the content of the second short message refers to book coupons needed to be viewed by the user, the button 32 “view now” is provided. In another embodiment of the present disclosure, as shown in FIG. 3C, there is the content of the short messages from the service telephone number “106980000762” of the official website “Qunar.com”. In the content of the first short message, since the content of the first short message refers to the payment and orders, the button 33 “edit orders” and the button 34 “pay now” are provided. In the content of the second short message, since the content of the second short message refers to hotels and routes, the button 35 “search for routes” and the button 36 “telephone counsel” are provided. It can be seen from the content of the short messages and the displayed buttons shown in FIGS. 3B and 3C that, in embodiments of the present disclosure, the merchant may display the buttons related to the content of the short messages to be sent when displaying the content of the short messages according to the content of the short message to be sent, thus avoiding the case that the user needs to restart the related application after exiting the short message, and simplifying the operations of the user.

In step S304, it is monitored whether the button is clicked by a user.

In step S305, it is determined to jump from a user interface of the short message application to a second user interface corresponding to the button if it is monitored that the button is clicked by the user.

In an embodiment of the present disclosure, the content displayed in the second user interface is related to the content of the short message. For example, for the button 31 “change password” shown in FIG. 3B, if the user clicks the button 31, the content displayed in the second user interface is an input option for inputting an original password by the user and an input option for inputting a new password. The description of other buttons is related to their names, which will not be elaborated herein.

In this embodiments, the displaying style of the content of the short message in the short message application of the terminal device is determined from the short message displaying rule database according to the telephone number and the content of the short message, and the content of the short message is displayed in the short message application according to the displaying style, such that the displayed content of the short message may include the button with which the user may perform the related operation, and the corresponding redirection may occur by means of the button in the interface of the content of the short message, thus avoiding the case that the user needs to perform the operation related to the content of the short message manually after closing the short message, and greatly increasing the convenience of performing the operation based on the content of the short message for the user.

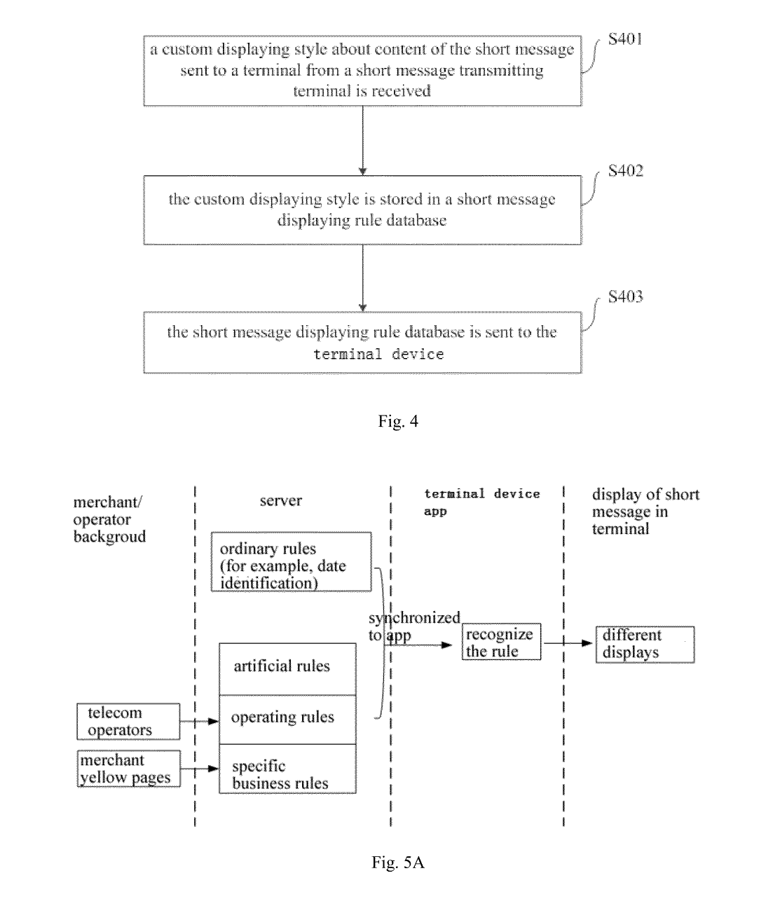

FIG. 4 is a flow chart showing a method for determining a display of a short message according to an exemplary embodiment, and the method for determining a display of a short message may be applied to a server. As shown in FIG. 4, the method for determining a display of a short message includes following steps S401-S403.

In step S401, a custom displaying style about content of the short message sent to a terminal from a short message transmitting terminal is received.

In step S402, the custom displaying style is stored in a short message displaying rule database.

In an embodiment of the present disclosure, the custom displaying style may be customized by the short message transmitting terminal according to the content of the short message to be sent. Again referring to FIG. 3B, there is the content of the short messages sent by the courier with the telephone number “1065753261062” to the terminal device. In the content of the first short message, since the content of the first short message refers to the password security, the displaying rule required to be determined in the short message displaying rule database is to provide the button 31 “change password.” In the content of the second short message, since content of the second short message refers to book coupons needed to be viewed by the user, the displaying rule required to be determined in the short message displaying rule database is to provide the button 32 “view now.” In another embodiment of the present disclosure, as shown in FIG. 3C, there is the content of the short messages from the service telephone number “106980000762” of the official website “Qunar.com.” In the content of the first short message, since the content of the first short message refers to the payment and orders, the displaying rule required to be determined in the short message displaying rule database is to provide the button 33 “edit orders” and the button 34 “pay now.” In the content of the second short message, since the content of the second short message refers to hotels and routes, the displaying rule required to be determined in the short message displaying rule database is to provide the button 35 “search for routes” and the button 36 “telephone counsel.” It can be seen from the content of the short messages and the displayed buttons shown in FIGS. 3B and 3C that, in embodiments of the present disclosure, the merchant may customize the displaying styles according to the content of the short messages needed to be sent, and may store the customized displaying styles in the short message displaying rule database, thus avoiding the case that the user needs to restart the related application after exiting the short message, and simplifying the operations of the user.

In step S403, the short message displaying rule database is sent to the terminal device.

In an embodiment of the present disclosure, concerning the process of realizing the display of the content of the short message by the terminal device according to the short message displaying rule database, reference is made to the above described embodiments, which will not be elaborated herein.

In this embodiment of the present disclosure, the custom displaying style about the content of the short message sent to the terminal device from the short message transmitting terminal is received, and the custom displaying style is stored in the short message displaying rule database, such that the user needs not restart the related application after exiting the short message, thus simplifying the operations of the user.

In an embodiment of the present disclosure, the method for determining a display of a short message further includes following steps of: determining a first displaying rule determined by the short message transmitting terminal in the short message displaying rule database; determining priorities of the content of the short message and a telephone number of the short message transmitting terminal according to the first displaying rule determined by the short message transmitting terminal in the short message displaying rule database.

In an embodiment of the present disclosure, the method for determining a display of a short message further includes following step of: sending an updated short message displaying rule database to the terminal device if the short message displaying rule database is updated.

Concerning details about how to display the content of the short message in the terminal device, reference is made to the following embodiments.

Thus, with the above described methods provided by embodiments of the present disclosure, the displaying style of the content of the short message in the short message application of the terminal device is determined from the short message displaying rule database according to the telephone number and the content of the short message, and the content of the short message is displayed in the short message application according to the displaying style, such that the content of the short message may be displayed in diverse ways in the terminal device. Further, an operation related to the content of the short message may be added by means of the short message displaying rule database, and if the user performs the operation related to the content of the short message, the corresponding redirection may occur on the interface of the content of the short message, such that the case that the user needs to perform the operation related to the content of the short message manually after closing the short message may be avoided, thus greatly increasing the convenience of performing the operation based on the content of the short message for the user.

FIG. 5A is a schematic diagram illustrating how to configure a short message displaying rule database according to an exemplary embodiment, FIG. 5B is a schematic diagram illustrating a custom displaying style of content of a short message according to an exemplary embodiment. In an embodiment shown in FIG. 5A, at the merchant/operator background side, the telecom operators and the merchant yellow pages respectively set the required custom displaying styles of the content of the short messages on a server according to operating rules and specific business rules. The server stores a lot of custom displaying styles of various merchants and the like in the short message displaying rule database, so as to form different displaying rules of content of the short messages. In addition, the displaying rules (artificial rules) may be set manually in the server. In addition, the server also may set the general displaying rules according to the hobbies and habits that the terminal device sends the content of the short messages, for example, the date and time in the content of the short message may be displayed in the form of the text link.

After obtaining the displaying rules set by various merchants and telecom operators, the server updates them to the application of the terminal device by means of short message displaying rule database. After receiving the content of the short message from the short message transmitting terminal, the application of the terminal device identifies the telephone number and the content of the short message, and determines the priorities of the displaying rules, and finally displays the content of the short message in the user interface of the application of the terminal device according to a method in above described embodiments.

In an embodiment of the present disclosure, as shown in FIG. 5B, the custom displaying style 50 of the China Merchant Bank is illustrated. In the region 51 “send number or segment of number” in the custom displaying style 50, the corresponding segment “1065877777X” of number is set. In the region 52 “set text template,” the text template of content of the short message to be sent is set. If the China Merchant Bank needs to display the consecutive characters or the buttons in the region 52 “set text template,” the button and the text link displayed in the short message application of the terminal device may be set in the region 53 of “set button” and the region 54 “text on button.” If the China Merchant Bank sends the custom displaying styles to the server, the server stores the custom displaying styles in the short message displaying rule database. After receiving the content of the short message sent by China Merchant Bank through the segment of telephone number, the short message application identifies the telephone number and the content of the short message, and determines priorities of the displaying rules according to the displaying rules in the short message displaying rule database, and finally displays the content of the short message in the user interface of the short message application of the terminal device according to a method in above described embodiments.

It can be seen that, the buttons and the text links in embodiments of the present disclosure shown in FIGS. 2A and 3A may be combined to form a new embodiment, such that the content of the short message may be displayed in a form of button, also may be displayed in a form of text link or hypertext link in the user interface of the short message application.

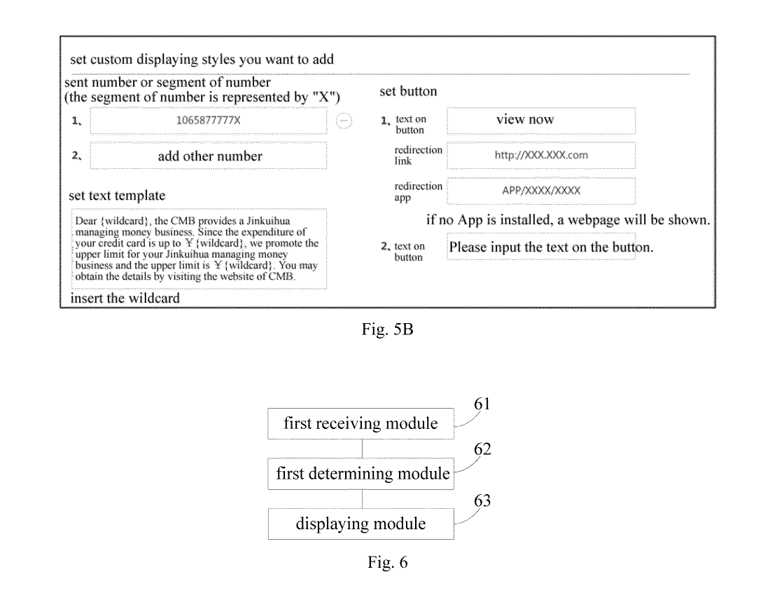

FIG. 6 is a block diagram showing a device for displaying content of a short message according to an exemplary embodiment. The device for displaying content of a short message may be applied to a terminal device. As shown in FIG. 6, the device for displaying content of a short message includes a first receiving module 61, a first determining module 62 and a displaying module 63.

The first receiving module 61 is configured to receive the content of the short message from a short message transmitting terminal and to determine a telephone number corresponding to the short message transmitting terminal.

The first determining module 62 is configured to determine a displaying style of the content of the short message in a short message application of a terminal device from a short message displaying rule database according to the telephone number determined by the first receiving module 61 and the content of the short message received by the first receiving module 61.

The displaying module 63 is configured to display the content of the short message received by the first receiving module 61 in the short message application according to the displaying style determined by the first determining module 62.

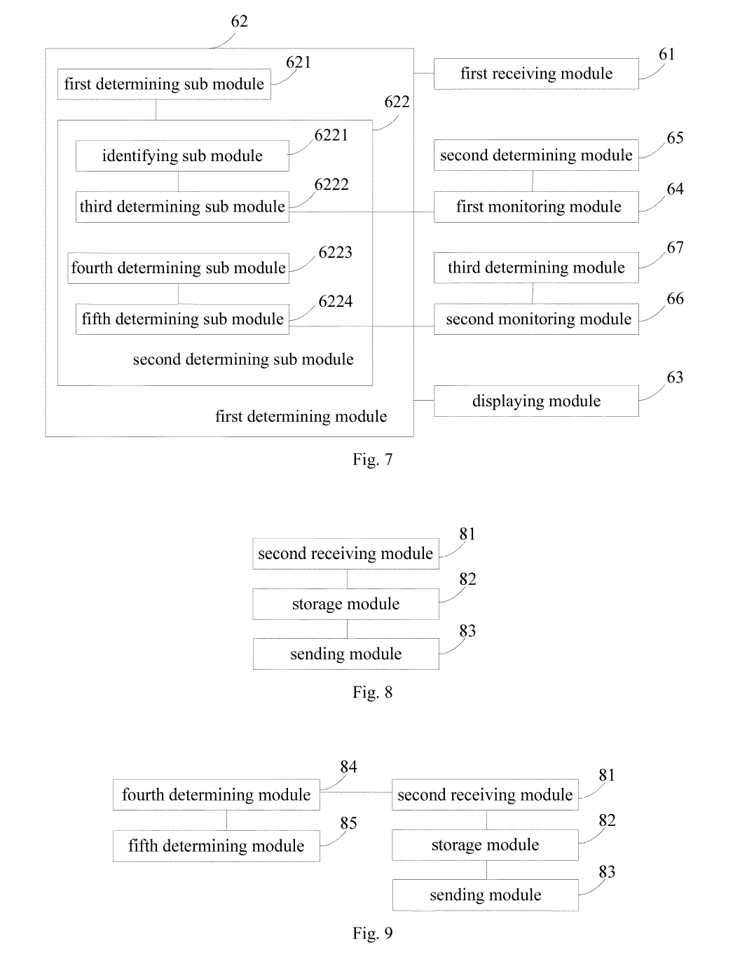

As shown in FIG. 7, the first determining module 62 may include a first determining sub-module 621 and a second determining sub-module 622.

The first determining sub-module 621 is configured to determine priorities of the telephone number determined by the first receiving module 61 and the content of the short message received by the first receiving module 61 for the displaying style of the content of the short message according to a first displaying rule in the short message displaying rule database.

The second determining sub-module 622 is configured to determine the displaying style of the content of the short message in the short message application of the terminal device according to the priorities determined by the first determining sub-module 621.

In an embodiment of the present disclosure, if the priority of the content of the short message is higher than that of the telephone number, the second determining sub-module 622 may include an identifying sub-module 6221 and a third determining sub-module 6222.

The identifying sub-module 6221 is configured to identify consecutive characters in the content of the short message received by the first receiving module 61 according to a second displaying rule determined in the short message displaying rule database.

The third determining sub-module 6222 is configured to determine a displaying style of the consecutive characters determined by the identifying sub-module 6221 as a text link in the short message application of the terminal device.

In an embodiment of the present disclosure, the device may further include a first monitoring module 64 and a second determining module 65.

The first monitoring module 64 is configured to monitor whether the text link determined by the third determining sub-module 6222 is clicked by a user.

The second determining module 65 is configured to determine to jump from a user interface of the short message application to a first user interface corresponding to the text link if the first monitoring module 64 monitors that the text link is clicked by a user.

In an embodiment of the present disclosure, if the priority of the telephone number is higher than that of the content of the short message, the second determining sub-module 622 may include a fourth determining sub-module 6223 and a fifth determining sub-module 6224.

The fourth determining sub-module 6223 is configured to identify a third displaying rule determined by the short message transmitting terminal corresponding to the telephone number in the short message displaying rule database.

The fifth determining sub-module 6224 is configured to determine a button associated with the content of the short message according to the third displaying rule identified by the fourth determining sub-module 6223, in which the third displaying rule is determined by the short message transmitting terminal corresponding to the telephone number in the short message displaying rule database.

In an embodiment of the present disclosure, the device may further include a second monitoring module 66 and a third determining module 67.

The second monitoring module 66 is configured to monitor whether the button determined by the fifth determining sub-module 6224 is clicked by a user.

The third determining module 67 is configured to determine to jump from a user interface of the short message application to a second user interface corresponding to the button if the second monitoring module 66 monitors that the button is clicked by the user.

In an embodiment of the present disclosure, the device may further include an updating module 68.

The updating module 68 is configured to update the short message displaying rule database adopted by the first determining module 62 if it is determined that the displaying styles in the short message displaying rule database are updated.

FIG. 8 is a block diagram showing a device for determining a display of a short message according to an exemplary embodiment. The device for determining a display of a short message may be applied to the server. As shown in FIG. 8, the device for determining a display of a short message includes a second receiving module 81, a storage module 82 and a sending module 83.

The second receiving module 81 is configured to receive a custom displaying style about content of the short message sent to a terminal device from a short message transmitting terminal.

The storage module 82 is configured to store the custom displaying style received by the second receiving module 81 in a short message displaying rule database.

The sending module 83 is configured to send the short message displaying rule database stored by the storage module 82 to the terminal device.

As shown in FIG. 9, the device may further include a fourth determining module 84 and a fifth determining module 85.

The fourth determining module 84 is configured to determine a first displaying rule determined by the short message transmitting terminal in the short message displaying rule database.

The fifth determining module 85 is configured to determine priorities of the content of the short message and a telephone number of the short message transmitting terminal according to the first displaying rule determined by the fourth determining module 84, in which the first displaying rule is determined by the short message transmitting terminal in the short message displaying rule database.

In an embodiment of the present disclosure, the sending module 83 is further configured to send an updated short message displaying rule database to the terminal device if the short message displaying rule database stored by the storage module 82 is updated.

With respect to the devices in the above embodiments, the specific manners for performing operations for individual modules therein have been described in detail in the embodiments regarding the methods, which are not elaborated herein again.

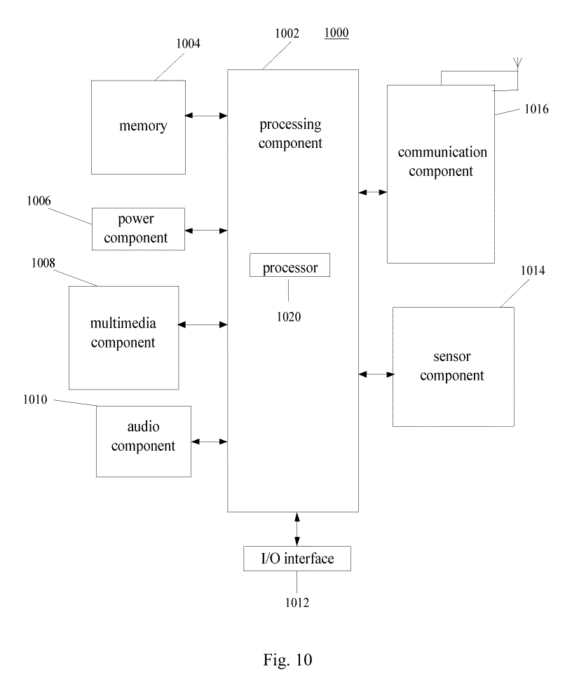

FIG. 10 is a block diagram suitable for a terminal device for displaying content of a short message according to an exemplary embodiment. For example, the terminal device 1000 may be a mobile phone, a computer, a digital broadcast terminal, a messaging device, a gaming console, a tablet, a medical device, an exercise equipment, a personal digital assistant, and the like.

Referring to FIG. 10, the terminal device 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the terminal device 1000, such as the operations associated with display, telephone calls, data communications, camera operations, and recording operations. The processing component 1002 may include one or more processors 1020 to execute instructions to perform all or part of the steps in the above described methods. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the terminal device 1000. Examples of such data include instructions for any applications or methods operated on the terminal device 1000, contact data, phonebook data, messages, pictures, videos, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the terminal device 1000. The power component 1006 may include a power management system, one or more power sources, and any other components associated with the generation, management, and distribution of power in the terminal device 1000.

The multimedia component 1008 includes a screen providing an output interface between the terminal device 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1008 includes a front camera and/or a rear camera. The front camera and the rear camera may receive an external multimedia datum while the terminal device 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (“MIC”) configured to receive an external audio signal when the terminal device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide status assessments of various aspects of the terminal device 1000. For instance, the sensor component 1014 may detect an open/closed status of the terminal device 1000, relative positioning of components, e.g., the display and the keypad, of the terminal device 1000, a change in position of the terminal device 1000 or a component of the terminal device 1000, a presence or absence of user contact with the terminal device 1000, an orientation or an acceleration/deceleration of the terminal device 1000, and a change in temperature of the terminal device 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the terminal device 1000 and other devices. The terminal device 1000 can access a wireless network based on a communication standard, such as WiFi, 2G or 3G or a combination thereof. In one exemplary embodiment, the communication component 1016 receives a broadcast signal or broadcast associated information from an external broadcast management system via a broadcast channel. In one exemplary embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1004, executable by the processor 1020 in the terminal device 1000, for performing the above-described methods. For example, the non-transitory computer-readable storage medium may be a ROM, a RAM, a CD-ROM, a magnetic tape, a floppy disc, an optical data storage device, and the like.

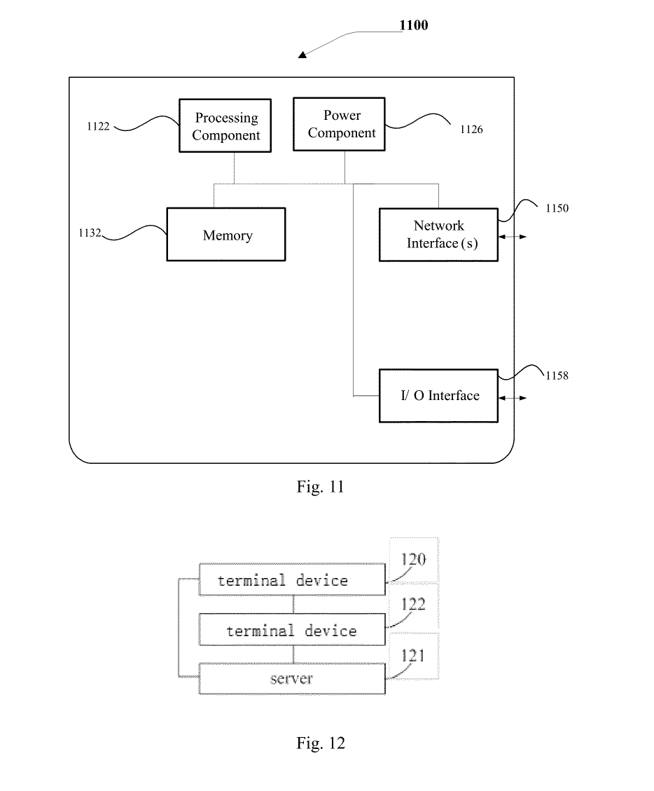

FIG. 11 is a block diagram suitable for a server for determining a display of a short message according to an exemplary embodiment. The server 1100 may be a server. Referring to FIG. 11, the server 1100 may include a processing component 1122 further including one or more processors, and memory resources represented by a memory 1132, configured to store instructions executable by the processing component 1122, for example, applications. The applications stored in the memory 1132 may include one or more modules in which each module is corresponding to a set of instructions. In addition, the processing component 1122 is configured to execute the instructions to perform all or part of the steps in the above described methods.

The server 1100 further includes a power component 1126 configured for a power management of the server 1100, a wired or wireless network interface 1150 configured to connect the server 1100 to the network, and an input/output (I/O) interface 1158. The server 1100 may be based on an operating system stored in the memory 1132, for example, Windows Server™, Mac OS X™, Unix™, Linux™, FreeBSD™ and the like.

FIG. 12 is a block diagram showing a system for displaying content of a short message according to an exemplary embodiment. The system for displaying content of a short message includes a server 121 and a terminal device 122.

The server 121 is configured to receive a custom displaying style about the content of the short message sent to the terminal device 122 from a short message transmitting terminal (for example, the terminal device 120); to store the custom displaying style in a short message displaying rule database; and to send the short message displaying rule database to the terminal device 122.

The terminal device 122 is configured to receive the content of the short message from the short message transmitting terminal (for example, the terminal device 120) and to determine a telephone number corresponding to the terminal device 120; to determine a displaying style of the content of the short message in a short message application of the terminal device 122 from the short message displaying rule database according to the telephone number and the content of the short message; to display the content of the short message in the short message application according to the displaying style.

In this embodiment of the present disclosure, the terminal device 122 determines the displaying style of the content of the short message in the short message application of the terminal device from the short message displaying rule database according to the telephone number and the content of the short message, and displays the content of the short message in the short message application according to the displaying style, such that the content of the short message may be displayed in diverse ways in the terminal device. Further, an operation related to the content of the short message may be added by means of the short message displaying rule database, and if the user performs the operation related to the content of the short message, the corresponding redirection may occur on the interface of the content of the short message, thus avoiding the case that the user needs to perform the operation related to the content of the short message manually after closing the short message, and greatly increasing the convenience of performing the operation based on the content of the short message for the user.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying content of a short message in a terminal device, comprising:
receiving the content of the short message from a short message transmitting terminal and determining a telephone number corresponding to the short message transmitting terminal;
determining a displaying style of the content of the short message from a short message displaying rule database according to the telephone number and the content of the short message; and
displaying the content of the short message in a short message application of the terminal device according to the displaying style.

2. The method according to claim 1, wherein determining the displaying style of the content of the short message comprises:
determining, according to a first displaying rule in the short message displaying rule database, priorities of the telephone number and the content of the short message for the displaying style of the content of the short message; and
determining the displaying style of the content of the short message according to the priorities.

3. The method according to claim 2, wherein if the priority of the content of the short message is higher than that of the telephone number, determining the displaying style of the content of the short message according to the priorities comprises:
identifying consecutive characters in the content of the short message according to a second displaying rule in the short message displaying rule database; and
determining a displaying style of the consecutive characters as a text link in the short message application of the terminal device.

4. The method according to claim 3, further comprising:
monitoring whether the text link is clicked by a user; and
determining to jump from a user interface of the short message application to a first user interface corresponding to the text link if it is monitored that the text link is clicked by the user.

5. The method according to claim 2, wherein if the priority of the telephone number is higher than that of the content of the short message, determining the displaying style of the content of the short message according to the priorities comprises:
identifying a third displaying rule, the third displaying rule being determined by the short message transmitting terminal from the short message displaying rule database; and
determining, according to the third displaying rule, a button associated with the content of the short message.

6. The method according to claim 5, wherein displaying the content of the short message comprises:
displaying the button with the content of the short message by the short message application.

7. The method according to claim 6, further comprising:
monitoring whether the button is clicked by a user; and
determining to jump from a user interface of the short message application to a second user interface corresponding to the button if it is monitored that the button is clicked by the user.

8. The method according to claim 1, wherein the short message displaying rule database is updated if it is determined that displaying styles in the short message displaying rule database are updated.

9. A terminal device for displaying content of a short message, comprising:
a processor; and
a memory for storing instructions executable by the processor,
wherein the processor is configured to:
receive the content of the short message from a short message transmitting terminal and determine a telephone number corresponding to the short message transmitting terminal;
determine a displaying style of the content of the short message from a short message displaying rule database according to the telephone number and the content of the short message; and
display the content of the short message in a short message application of the terminal device according to the displaying style.

10. The terminal device according to claim 9, wherein the processor is configured to determine the displaying style of the content of the short message by steps of:
determining, according to a first displaying rule in the short message displaying rule database, priorities of the telephone number and the content of the short message for the displaying style of the content of the short message; and
determining the displaying style of the content of the short message according to the priorities.

11. The terminal device according to claim 10, wherein if the priority of the content of the short message is higher than that of the telephone number, the processor is configured to determine the displaying style of the content of the short message according to the priorities by steps of:
identifying consecutive characters in the content of the short message according to a second displaying rule in the short message displaying rule database; and
determining a displaying style of the consecutive characters as a text link in the short message application of the terminal device.

12. The terminal device according to claim 11, wherein the processor is further configured to:
monitor whether the text link is clicked by a user; and
determine to jump from a user interface of the short message application to a first user interface corresponding to the text link if it is monitored that the text link is clicked by the user.

13. The terminal device according to claim 10, wherein if the priority of the telephone number is higher than that of the content of the short message, the processor is configured to determine the displaying style of the content of the short message according to the priorities by steps of:
identifying a third displaying rule, the third displaying rule being determined by the short message transmitting terminal from the short message displaying rule database; and
determining, according to the third displaying rule, a button associated with the content of the short message.

14. The terminal device according to claim 13, wherein displaying the content of the short message comprises:
displaying the button with the content of the short message by the short message application.

15. The terminal device according to claim 14, wherein the processor is further configured to:
monitor whether the button is clicked by a user; and
determine to jump from a user interface of the short message application to a second user interface corresponding to the button if it is monitored that the button is clicked by the user.

16. The terminal device according to claim 9, wherein the short message displaying rule database is updated if it is determined that displaying styles in the short message displaying rule database are updated.

17. A server for determining a display of a short message, comprising:
a processor; and
a memory for storing instructions executable by the processor,
wherein the processor is configured to:
receive a custom displaying style about content of the short message sent to a terminal device from a short message transmitting terminal;
store the custom displaying style in a short message displaying rule database; and
send the short message displaying rule database to the terminal device.

18. The server according to claim 17, wherein the processor is further configured to:
identify a first displaying rule, the first displaying rule being determined by the short message transmitting terminal from the short message displaying rule database; and
determine priorities of the content of the short message and a telephone number of the short message transmitting terminal according to the first displaying rule.

19. The server according to claim 17, wherein the processor is further configured to:
send an updated short message displaying rule database to the terminal device if the short message displaying rule database is updated.

20. A system for displaying content of a short message, comprising a server and a terminal device, wherein
the server is configured to receive a custom displaying style about the content of the short message sent to the terminal device from a short message transmitting terminal; store the custom displaying style in a short message displaying rule database; and send the short message displaying rule database to the terminal device;
the terminal device is configured to receive the content of the short message from the short message transmitting terminal and determine a telephone number corresponding to the short message transmitting terminal; determine a displaying style of the content of the short from the short message displaying rule database according to the telephone number and the content of the short message; and display the content of the short message in a short message application of the terminal device according to the displaying style.
